(19) United States
(12) Patent Application Publication
(10) Pub. No.: US 2010/0171698 A1
(43) Pub. Date: Jul. 8, 2010

(54) DIGITAL TELEVISION AND METHOD OF DISPLAYING CONTENTS USING THE SAME

(75) Inventors: HYUN MIN KIM, Seoul (KR); Jung Han Ryu, Seoul (KR); Kyoung Joung Kim, Seoul (KR); Jeong A. Shin, Seoul (KR); Jung Eun Kim, Seoul (KR); Min Su Song, Seoul (KR); Na Ri Lee, Seoul (KR); Kyung Mi Park, Seoul (KR); Byung Soo Kim, Seoul (KR); Yun Mi Park, Seoul (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 12/648,438

(22) Filed: Dec. 29, 2009

(30) Foreign Application Priority Data
Dec. 29, 2008 (KR) 10-2008-0135916

(51) Int. Cl. G06F 3/033; H04N 5/44

(52) U.S. Cl. 345/158; 348/734; 348/E05.096

(57) ABSTRACT

A DTV and a method of displaying content using the same are provided. a DTV includes: a plurality of first and second display units physically isolated from each other; a communication unit configured to communicate with an external remote control; and a control unit configured to move a content between the first and second display units in response to a motion of the remote control sensed by a signal received from the remote control through the communication unit.

This nonprovisional application claims priority under 35 U.S.C. §119(a) on Patent Application No. 10-2008-0135916 filed in Republic of Korea on Dec. 29, 2008 the entire contents of which are hereby incorporated by reference.

### BACKGROUND

1. Field

This document relates to a digital television (DTV), and more particularly, to a DTV, which can move contents between a plurality of display units provided in the DTV in response to a motion of a remote control for sensing a motion, and a method of displaying contents using the same.

2. Related Art

Recently, a digital television (DTV) capable of outputting high definition video and high quality sound is widely spread and commercially available. Moreover, an internet protocol television (IPTV), which is a kind of DTV, which can be connected to the internet is to be distributed.

In recent years, electronic equipment tend to focus on satisfying the demands of users with individual needs, shifting focus away from delivering advancements and improvements in terms of design. Thus, there are being built production and sales systems, which take individual preferences, such as customized manufactured products and the diversification of user options, into account. Moreover, there is a trend toward the development of user-oriented interfaces which allow the equipment itself to adjust the use environment according to user preferences.

Owing to the recent rapid progress of the terminal technology and the communication technology, it is made possible to provide a variety of contents through a DTV. Hence, there is an urgent need for the provision of an interface capable of displaying contents provided through a DTV in various manners.

### SUMMARY

An aspect of this document is to provide a DTV, which is capable of displaying a variety of contents provided through the DTV in a new manner different from the conventional one, and a method of displaying contents using the same.

In one aspect of the present invention, there is provided a DTV including: a plurality of first and second display units physically isolated from each other; a communication unit configured to communicate with an external remote control; and a control unit configured to move a content between the first and second display units in response to a motion of the remote control sensed by a signal received from the remote control through the communication unit.

In another aspect of the present invention, there is provided a method of displaying contents using a DTV, which can communicate with a remote control for sensing a motion and includes a first display unit and a second display unit physically isolated from each other, the method including: displaying a content on the first display unit; and moving the displayed content between the first display unit and the second display unit in response to a motion of the remote control.

The DTV and the method of displaying contents using the same according to the present invention can give a new impression to a user by providing a new contents display method, and allows a user to control contents easily and conveniently because the contents are moved in response to the motion of the remote control for sensing a motion.

### BRIEF DESCRIPTION OF THE DRAWINGS

The implementation of this document will be described in detail with reference to the following drawings in which like numerals refer to like elements.

FIG. 1 is a view schematically illustrating a system to which the present invention is applied;

FIG. 2 is a block diagram of a DTV according to an exemplary embodiment of the present invention;

FIG. 3a is a view illustrating an example of the external appearance of a remote control according to an exemplary embodiment of the present invention;

FIG. 3b is a block diagram of the remote control according to an exemplary embodiment of the present invention.

FIG. 4 is a flowchart of a method of displaying contents using a DTV according to an exemplary embodiment of the present invention.

FIG. 5 is a view illustrating an example in which a plurality of contents is displayed on a first display unit;

FIG. 6 illustrates an example of a screen where the first content is selected;

FIG. 7 is a flow chart of the movement of the first content in response to a motion of a 3D pointing device according to a first exemplary embodiment of the present invention;

FIGS. 8a to 8c are views illustrating examples of a screen where the step S142 is performed;

FIG. 9 is a view for explaining the motion distance and motion speed of the 3D pointing device;

FIG. 10 is a flowchart of the movement of the first content in response to the motion of the 3D pointing device according to a second exemplary embodiment of the present invention; and

FIG. 11 is a view illustrating an example of a screen where the step S145 and the step S146 are performed.

### DETAILED DESCRIPTION

The above-mentioned objects, features, and advantages will be more apparent by the following detailed description associated with the accompanying drawings. Hereinafter, preferred embodiments of the present invention will be set forth in detail with reference to the accompanying drawings. Throughout the specification, the same reference numerals represent the same components. Further, in the following description, well-known functions or constructions related to the present invention will not be described in detail if it appears that they could obscure the invention in unnecessary detail.

Although a suffix “module” or “unit” is used for constituent elements described in the following description, it is intended only for easy description of the specification. The suffix itself has no meaning or function to distinguish the constituent element using the suffix from the constituent element using no suffix.

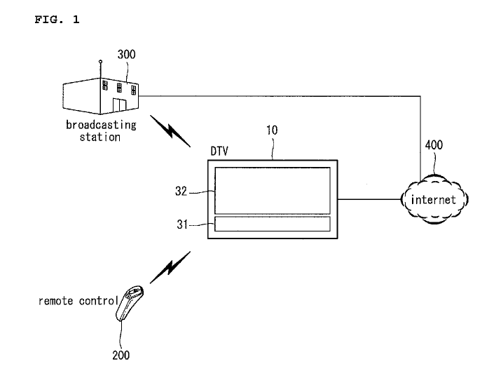

FIG. 1 is a view schematically illustrating a system to which the present invention is applied. As illustrated in FIG. 1, the system may comprise a DTV 10, a remote control 200, a broadcasting station 300, and the internet 400.

The remote control 200 may be a 3-dimensional (3D) pointing device. The 3D pointing device may sense a 3D motion to transmit information about the sensed 3D motion to the DTV 10. The 3D motion may correspond to a command for controlling the DTV 10. A user can transmit a predetermined command to the DTV 10 by moving the 3D pointing device in a space. The 3D pointing device may be provided with various key buttons. The user can enter various commands by the key buttons.

The DTV 10 can receive a broadcast signal from the broadcasting station 300 and output it. Moreover, the DTV 10 may be provided with a device capable of connecting to the internet 400 through transmission/control protocol/internet protocol (TCP/IP).

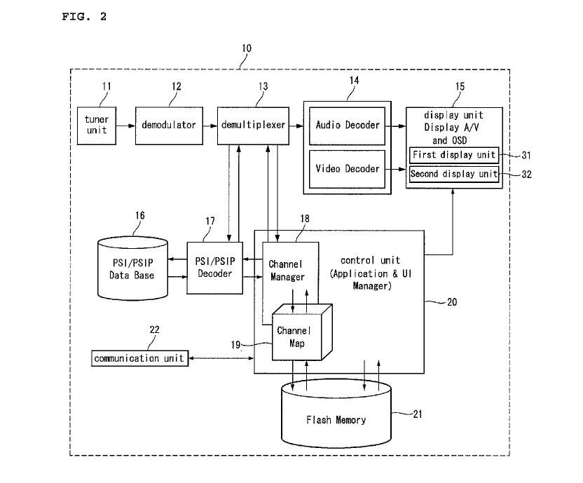

FIG. 2 is a block diagram of a DTV according to an exemplary embodiment of the present invention.

The DTV according to the exemplary embodiment of the present invention may comprise a tuner unit 11, a demodulator 12, a demultiplexer 13, an audio/video decoder 14, display unit 15, a program and system information/program and system information protocol (PSI/PSIP) database 16, a PSI/PSIP decoder 17, a channel manager 18, a channel map 19, a control unit 20, a flash memory 21, and a communication unit 22.

The tuner unit 11 may receive a digital broadcast signal containing a PSI/PSIP table. The operation of the tuner unit 11 may be controlled by the channel manager 18. Thus, the tuner unit 11 records the result of the received digital broadcast signal in the channel manager 18. The tuner unit 11 may be capable of multichannel reception because it is equipped with a plurality of tuners.

The demodulator 12 functions to receive the signal tuned by the tuner unit 11 and demodulate it into a VSB/EVSB (Vestigial Side Band/Enhanced Vestigial Side Band) signal.

The demultiplexer 13 demultiplexes received transport packets demodulated by the demodulator 12 to audio, video and PSI/PSIP table data.

The demultiplexing of the PSI/PSIP table data can be controlled by the PSI/PSIP decoder 17. The demultiplexing of the audio and video data can be controlled by the channel manager 18.

When the PSI/PSIP decoder 17 sets a packet identifier (PID) for a desired table as a condition, the demultiplexer 13 filters the sections of the PSI/PSIP table for satisfying the PID and transmits the sections to the PSI/PSIP decoder 17. When the channel manager 18 sets an A/V PID of a corresponding virtual channel as a condition, the demultiplexer 13 demultiplexes an A/V elementary stream (ES) and transmits the demultiplexed A/V ES to the A/V decoder 14. The A/V decoder 14 decodes the received broadcast data according to a corresponding encoding method.

The PSI/PSIP decoder 17 performs parsing of the PSI/PSIP section, reads the remaining actual section data which has not been section-filtered by the demultiplexer 13, and records the read data in the PSI/PSIP database 16.

The channel manager 18 may request the reception of a channel-related information table by referring to the channel map 19 and receive the result. At this time, the PSI/PSIP decoder 17 controls the demultiplexing of the channel-related information table and transmits a list of A/V PIDs to the channel manager 18.

The channel manager 18 may directly control the demultiplexer 13 using the received A/V PID to control the A/V decoder 14.

The control unit 20 may control a graphical user interface (GUI) for displaying the state of the receiver system with an on-screen display (OSD).

Also, the control unit 20 controls the above components, and controls the overall operation of the DTV 10.

The display unit 15 implements the broadcast data output from the A/V decoder 14 in audio and video. The display unit 15 may comprises a plurality of display units which are isolated from each other physically or logically. In this specification, it is assumed that the display unit 15 comprises a first display unit 31 and a second display unit 32. The display unit 15 may comprise three or more physical display units.

The first display unit 31 and the second display unit 32 may be identical or different in size and/or resolution.

At least one of the first display unit 31 and the second display unit 32 may receive broadcast data and output it, and may be equipped with all display functions of a typical DTV.

At least one of the first display unit 31 and the second display unit 32 can display data broadcasts, text broadcasts, subtitles, advertisements, etc that are separated from the broadcast data or separately received. Moreover, at least one of the first display unit 31 and the second display unit 32 can display additional information, such as stock information, weather information, etc, an instant message window, and so on. Furthermore, at least one of the first display unit 31 and the second display unit 32 may have no audio function. In addition, the first display unit 13 and the second display unit 32 may independently receive power to be driven independently from each other by a control signal output from the control unit 20.

The communication unit 22 may perform communication with the remote control 200. For instance, the communication unit 22 and the remote control 200 may perform communication by an RF communication method or an infrared communication method. A communication method between the remote control 200 and the DTV 10 is not limited to any particular method.

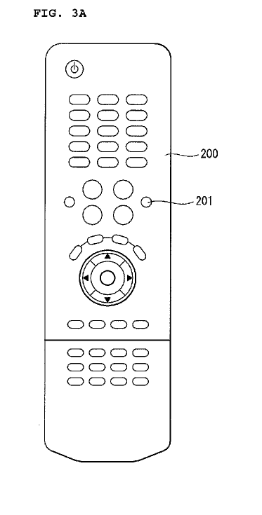

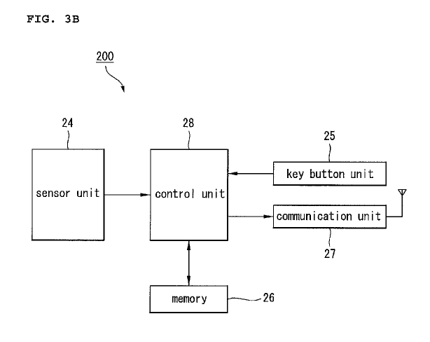

FIG. 3a is a view illustrating an example of the external appearance of the remote control 200 according to an exemplary embodiment of the present invention. FIG. 3b is a block diagram of the remote control 200 according to an exemplary embodiment of the present invention. Referring to FIGS. 3a and 3b, the remote control 200 according to one exemplary embodiment of the present invention will now be described in detail. The remote control 200 according to one exemplary embodiment of the present invention shown in FIGS. 3a and 3b may be the above-mentioned 3D pointing device or other device.

The remote control 200 according to the exemplary embodiment of the present invention may comprise a sensor unit 24, a key button unit 25, a memory 26, a communication unit 27, and a control unit 28.

The sensor unit 24 can sense a three-dimensional motion of the remote control 200. The sensor unit 24 includes at least one of a gyro sensor, a gravity sensor, an inertial sensor, a terrestrial-magnetism sensor, and an acceleration sensor. By using a combination of one or two or more of these sensors, the three-dimensional motion of the remote control 200 can be sensed.

The key button unit 25 is a device for receiving inputs of various information or commands, and may comprise at least one key button. For instance, as shown in FIG. 3a, the key button unit 25 may be provided on the front surface of the remote control 200.

The memory 26 stores a predetermined program for controlling general operation of the remote control 200, and can temporarily or permanently store data input and output when the control unit 28 carries out general operation of the remote control 200 and various data processed by the control unit 28.

The communication unit 27 transmits information about a motion sensed by the sensor unit 24 or a signal input through the key button unit 25 to the DTV 10.

The control unit 28 controls the above components, and carries out general operation of the remote control 200 according to exemplary embodiments of the present invention.

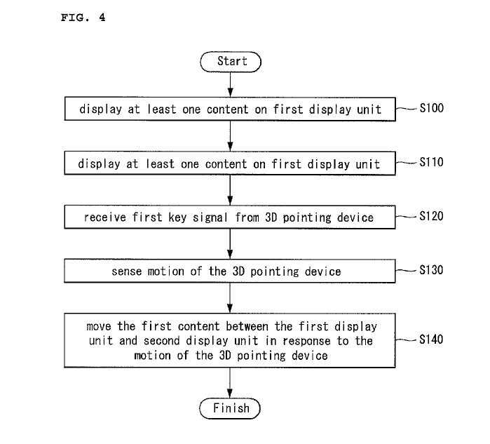

FIG. 4 is a flowchart of a method of displaying contents using a DTV according to an exemplary embodiment of the present invention. The method of displaying contents using a DTV according to the exemplary embodiment of the present invention can be implemented by the DTV 10 and the remote control 200 that have been described with reference to FIGS. 1 to 3. Now, referring to FIG. 4 and required drawings, the method of displaying contents using a DTV according to the exemplary embodiment of the present invention and the operations of the DTV 10 and the remote control 200 for implementing this method will be described in detail. The following description will be given under the assumption that the remote control 200 is the above-mentioned 3D pointing device.

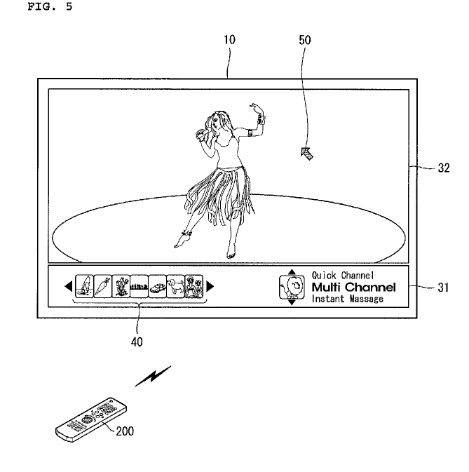

The control unit 20 displays at least one content on the first display unit 31 [S100]. FIG. 5 is a view illustrating an example in which a plurality of contents 40 is displayed on the first display unit 31.

The contents mentioned in the present invention may include still images, motion images, text, and objects. For instance, the contents may be icons, photographs, or broadcasts.

As shown in FIG. 5, the control unit 20 can display an indicator 50 which is movable in response to a motion of the 3D pointing device 200 on the display unit 15. The indicator 50 may be displayed on both of the first display unit 31 and the second display unit 32 or on any one of the first display unit 31 and the second display unit 32. The user can control the position of the indicator 50 by moving the 3D pointing device 200 in a space.

The control unit 20 can receive a selection signal for a first content among the at least one content 40 [S110]. The selection signal can be received from the 3D pointing device 200 through the communication unit 22.

For instance, the user can move the 3D pointing device 200 in a space such that the indicator 50 indicates a desired content (e.g., the first content). Also, the first content currently indicated by the indicator 50 can be selected by pressing a specific key allocated for the selection of a specific item from among a plurality of keys included in the key button unit 25.

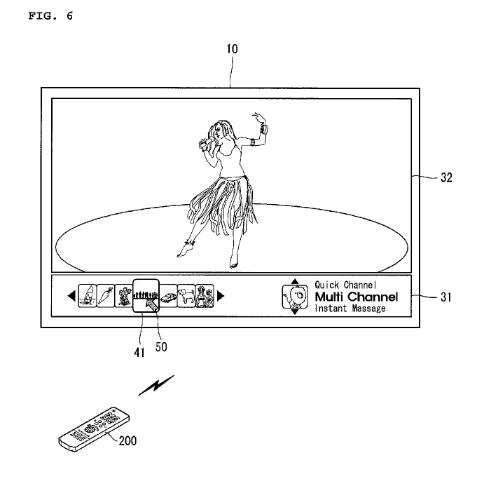

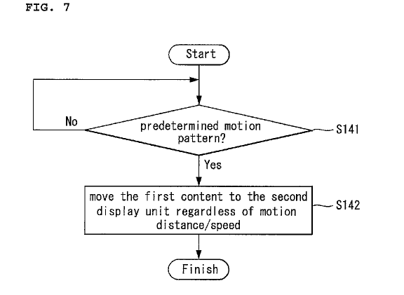

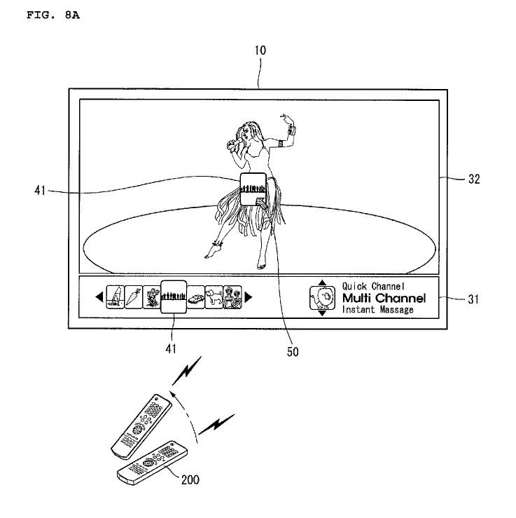

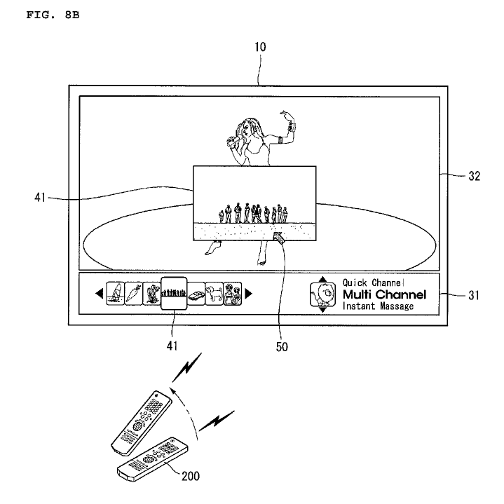

FIG. 6 illustrates an example of a screen where the first content 41 is selected. When the selection signal for the first content is received, the control unit 20 can control the display of the selected first content such that the selected first content is distinguished from other contents. For instance, referring to FIG. 6, the control unit 20 can make the size of the selected first content larger than the sizes of other contents. The user can be aware that the first content is currently selected based on the fact that the size of the first content is different from those of other contents.

The control unit 20 can receive a first key signal allocated for the movement of the selected first content from the 3D pointing device 200 through the communication unit 22. For instance, when the user presses a first key 201 for the movement of a content, the first key signal is transmitted to the DTV 10.

In order for the user to move the selected first content, the first key 201 may be configured to be pressed once, or the 3D pointing device 200 may be configured to be moved, with the first key 201 being pressed. More details thereof will be described later.

The control unit 20 senses the motion of the 3D pointing device 200 [S130]. The control unit 20 is able to sense the motion of the 3D pointing device 200 based on a motion signal received from the 3D pointing device 200 through the communication unit 22.

The control unit 20 moves the first content displayed on the first display unit 31 between the first display unit 31 and the second display unit 32 in response to the motion of the 3D pointing device 200 [S140].

The motion of the 3D pointing device 200 may be at least one of a linear motion and a rotary motion. For instance, if the motion of the 3D pointing device 200 forms a predetermined angle with respect to the ground (rotary motion), the control unit 20 can control the movement of the first content. Moreover, for example, if the 3D pointing device 200 is moved in a space while maintaining a predetermined angle with respect to the ground (linear motion), the control unit 20 can control the movement of the first content. Furthermore, if both of the linear motion and the rotary motion are sensed, the control unit 20 can control the movement of the first content.

In addition, the control unit 20 can control the movement of the first content depending on the direction of motion of the 3D pointing device 200 by considering the relative position of the first display unit 31 and the second display unit 32.

For instance, as shown in FIG. 5, if the first display unit 31 is located under the second display unit 32, the user can movement the first content to the second display unit 32 by moving the 3D pointing device 200 upward.

Also, if the first content is displayed on the second display unit 32, the user can move the first content to the first display unit 31 by moving the 3D pointing device 200 downward.

Additionally, for instance, if the first display unit 31 and the second display unit 32 are arranged left and right, the user can move the first content between the first display unit 31 and the second display unit 32 by moving the 3D pointing device 200 left and right.

The 3D pointing device 200 may be used for the control of other various functions of the DTV 10, as well as for the movement of contents mentioned in this document. Thus, the 3D pointing device 200 may require the above-mentioned first key 201. As previously described above, if the control unit 200 receives the first key signal indicating that the first key 201 has been pressed, the control unit 20 can enter a mode for moving the first content. Also, when a holding signal for the first key 201 is received, the control unit 20 can move the first content in response to the motion of the 3D pointing device 200. The holding signal represents a state in which the first key 201 continues to be pressed. For instance, the first content can be moved only when the user moves the 3D pointing device 200 while pressing the first key 201. If the user releases the first key 201, the first content may not be moved even if the user moves the 3D pointing device 200 in a space.

Besides, for example, with the indicator 50 indicating the first content, if the control unit 20 receives a motion signal of the 3D pointing device 200, simultaneously with the reception of the holding signal for the first key 201, the first content can be moved in response to the received motion signal. In this case, the selection of the first content performed in the step S110 may be the first key signal first received from the 3D pointing device 200.

Hereinafter, various exemplary embodiments regarding the movement of the first content in response to the motion of the 3D pointing device 200 will be described in conjunction with the step S140.

FIG. 7 is a flow chart of the movement of the first content in response to the motion of the 3D pointing device 200 according to a first exemplary embodiment of the present invention.

The control unit 20 determines whether or not the motion of the 3D pointing device 200 corresponds to a predetermined motion pattern [S141]. As a result of the determination in the step S141, if the motion of the 3D pointing device 200 corresponds to the predetermined motion pattern, the control unit 20 moves the first content to the second display unit 32 [S412].

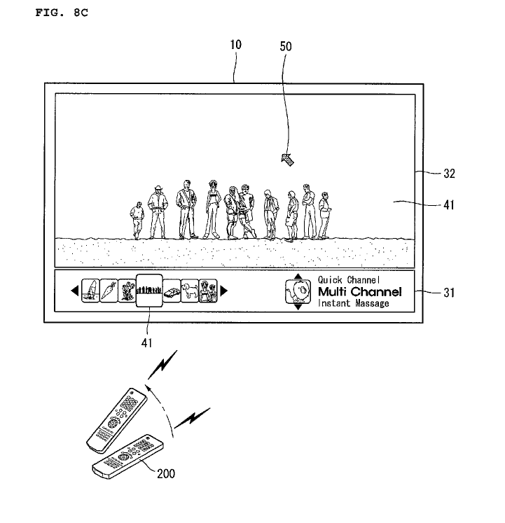

FIGS. 8a to 8c are views illustrating examples of a screen where the step S142 is performed. The control unit 20 can control the size of the first content in various manners while moving the first content to the second display unit 32.

For instance, referring to FIG. 8a, the first content can maintain its original size even after being moved from the first display unit 31 to the second display unit 32. Moreover, for instance, the control unit 20 can change the size of the first content by considering the size and/or resolution of the second display unit 32. Referring to FIG. 8b, as the first content is moved to the second display unit 32, the size of the first content may become larger than the size displayed on the first display unit 31. Also, referring to FIG. 8c, the control unit 20 can control the size of the first content such that the first content is displayed on the entire screen of the second display unit 32.

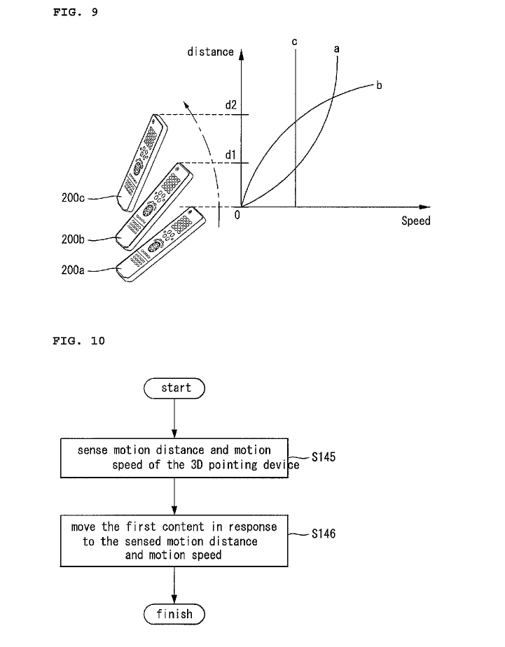

The control unit 20 can perform the step S142 regardless of the motion distance and motion speed of the 3D pointing device 200. FIG. 9 is a view for explaining the motion distance and motion speed of the 3D pointing device 200.

The motion distance mentioned in the present invention has at least two meanings: firstly, if the 3D pointing device 200 performs a linear motion, the motion distance may indicate a linear distance; and secondly, if the 3D pointing device 200 performs a rotary motion, the motion distance may indicate a rotary distance (rotary angle).

For example, if the 3D pointing device 200 is slightly moved a distance of greater than 0 from the position of reference numeral 200a to the position of reference numeral 200b, the control unit 20 can move the first content to the second display unit 32.

If the 3D pointing device 200 is moved more than a predetermined distance, the control unit 20 can perform the step S142. For instance, if the 3D pointing device 200 is moved at least a distance d1 from the position of reference numeral 200a, the control unit 20 can move the first content to the second display unit 32.

If the 3D pointing device 200 is accelerated, the control unit 20 can perform the step S142. FIG. 9 illustrates three profiles regarding the motion speed of the 3D pointing device 200: Profile a; Profile b; and Profile c. Profile a and Profile b show the case where the speed of the 3D pointing device 200 increases while the 3D pointing device 200 is in motion, and Profile C shows the case where the speed of the 3D pointing device 200 is constant while the 3D pointing device 200 is in motion. Besides, various speed profiles are available.

For instance, if the motion speed of the 3D pointing device 200 corresponds to Profile a or b, the step S142 can be performed. At this time, the 3D pointing device 200 can be adapted to be accelerated more than a predetermined distance such that the step S142 is performed. For instance, in FIG. 9, in the case where the 3D pointing device 200 corresponds to Profile a or b while being moved more than a distance from the position of 200a to the position of 200b, the step s142 can be performed.

Meanwhile, the movement of the first content may be controlled regardless of the motion speed of the 3D pointing device 200. For instance, referring to FIG. 9, if the motion speed of the 3D pointing device 200 corresponds to any of the three profiles regarding the motion speed: Profile a; Profile b; and Profile c, the movement of the first content can be controlled.

FIG. 10 is a flowchart of the movement of the first content in response to the motion of the 3D pointing device 200 according to a second exemplary embodiment of the present invention.

The control unit 20 senses the motion distance and motion speed of the 3D pointing device 200 [S145], and controls the movement of the first content such that the sensed motion distance and motion speed and the moving distance of the first content correspond to each other [S146].

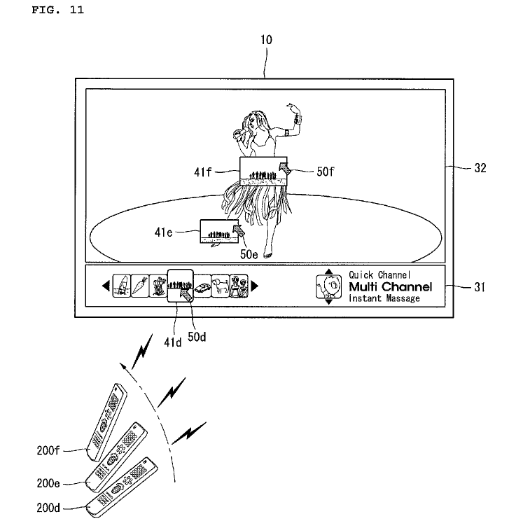

FIG. 11 is a view illustrating an example of a screen where the step S145 and the step S146 are performed.

If the position of the 3D pointing device 200 is indicated by reference numeral 200d, the position of the first content corresponds to reference numeral 41d. At this time, the position of the indicator 50 corresponds to reference numeral 50d. If the user performs a linear motion of the 3D pointing device 200 in an upward direction or a rotary motion thereof so as to form a predetermined angle with respect to the ground surface, the positions of the indicator 50 and the first content are slightly moved in the direction of the second display unit 32.

If the position of the 3D pointing device 200 is indicated by reference numeral 200e, the position of the first content corresponds to reference numeral 41e and the position of the indicator 50 corresponds to reference numeral 50e. If the 3D pointing device 200 continues to be moved and reaches the position corresponding to reference numeral 200f, the first content is moved as far as to the position corresponding to reference numeral 41f, and the indicator 50 is moved as far as to the position corresponding to reference numeral 50f.

Moreover, as stated above, the motion speed of the 3D pointing device 200 and the moving speed of the first content may be associated with each other. For example, if the 3D pointing device 200 is moved fast, the first content, too, is moved fast, while if the 3D pointing device 200 is moved slowly, the first content, too, is moved slowly.

As previously described, the moving direction of the 3D pointing device 200 and the moving direction of the first content may correspond to each other. For instance, if the 3D pointing device 200 is moved up and down and left and right, the first content, too, may be moved up and down and left and right.

While the foregoing exemplary embodiments have been described with respect to a case where contents are moved from the first display unit 31 to the second display unit 32, the present invention is not limited thereto. The same technical characteristics can be given to a case where contents are moved from the second display unit 32 to the first display unit 31.

Moreover, while the foregoing exemplary embodiments have been described with respect to the movement of contents between two display modules, the present invention is not limited thereto. The same technical characteristics can be given to a case where contents can be moved between three or more display modules.

The above-described method of displaying contents using the DTV according to the present invention may be provided as a program that causes a computer to execute the method. The program may be recorded and provided on a computer readable recording medium.

The method of displaying contents using the DTV according to the present invention can be implemented in software. When implemented in software, the elements of the invention are essentially the code segments to perform the necessary tasks. The program or code segments can be stored in a processor readable medium or transmitted by a computer data signal embodied in a carrier wave over a transmission medium or communication link.

The computer-readable recording medium includes any type of storage device that can store data readable by a computer system. Examples of the computer-readable recording medium include a ROM, RAM, CD-ROM, DVD-ROM, DVD-RAM, magnetic tape, floppy disk, hard disk, and optical data storage. The computer-readable recording medium can also be distributed over a network of connected computer systems such that the computer-readable code is stored and executed in a distributed fashion.

The present invention described above is not limited to the aforementioned exemplary embodiments and the accompanying drawings. It will be apparent that those skilled in the art can make various substitutions, modifications and changes thereto without departing from the technical spirit of the present invention. Further, the exemplary embodiments described in this document are not limitative, and all or some of the embodiments may be selectively combined so that they can be modified in various manners.

What is claimed is:

1. A DTV comprising:
a plurality of first and second display units physically isolated from each other;
a communication unit configured to communicate with an external remote control; and
a control unit configured to move a content between the first and second display units in response to a motion of the remote control sensed by a signal received from the remote control through the communication unit.

2. The DTV of claim 1, wherein the remote control is a 3D pointing device provided with a sensor for sensing a motion.

3. The DTV of claim 2, wherein the control unit is configured to receive a selection signal for the content from the 3D pointing device, and then control the movement of the content in response to the motion of the 3D pointing device.

4. The DTV of claim 3, wherein, when the selection signal for the content is received, the control unit is configured to control the display of the selected content such that the selected content is distinguished from other contents.

5. The DTV of claim 2, wherein, when a holding signal for a predetermined first key provided in the 3D pointing device is received, the control unit is configured to control the movement of the content in response to the motion of the 3D pointing device.

6. The DTV of claim 2, wherein the control unit is configured to control the movement of the content according to a predetermined motion pattern

7. The DTV of claim 6, wherein the control unit is configured to move the content between the first and second display units according to the predetermined motion pattern regardless of the motion distance and motion speed of the 3D pointing device.

8. The DTV of claim 6, wherein the predetermined motion pattern involves accelerating the 3D pointing device at more than a predetermined distance.

9. The DTV of claim of claim 2, wherein the control unit is configured to control the movement of the content such that the motion distance of the 3D pointing device and the moving distance of the content correspond to each other.

10. The DTV of claim 2, wherein the control unit is configured to control the movement of the content such that the motion speed of the 3D pointing device and the moving speed of the content correspond to each other.

11. The DTV of claim 2, wherein the control unit is configured to control the movement of the content such that the motion direction of the 3D pointing device and the moving direction of the content correspond to each other.

12. The DTV of claim 2, wherein the control unit is configured to display an indicator for indicating the motion of the 3D pointing device on the display unit displaying the content among the first and second display units.

13. The DTV of claim 2, wherein the motion of the 3D pointing device is at least one of a linear motion and a rotary motion.

14. A method of displaying contents using a DTV, which can communicate with a remote control for sensing a motion and comprises a first display unit and a second display unit physically isolated from each other, the method comprising:
displaying a content on the first display unit; and
moving the displayed content between the first display unit and the second display unit in response to a motion of the remote control.

15. The method of claim 14, wherein the remote control is a 3D pointing device provided with a sensor for sensing a motion.

16. The method of claim 15, wherein the moving of the content is performed after receiving a selection signal for the content from the 3D pointing device.

17. The method of claim 16, wherein the moving of the content comprises, if the selection signal is received, controlling the display of the selected content such that the selected content is distinguished from other contents.

18. The method of claim 15, wherein the moving of the content is performed upon receipt of a holding signal for a predetermined first key provided in the 3D pointing device.

19. The method of claim 15, wherein the moving of the content is performed according to a predetermined motion pattern.

20. The method of claim 19, wherein the moving of the content is performed regardless of the motion distance and motion speed of the 3D pointing device.

21. The method of claim 19, wherein the predetermined motion pattern involves accelerating the 3D pointing device at more than a predetermined distance.

22. The method of claim of claim 15, wherein, in the moving of the content, the movement of the content is controlled such that the motion distance of the 3D pointing device and the moving distance of the content correspond to each other.

23. The method of claim 15, wherein, in the moving of the content, the movement of the content is controlled such that the motion speed of the 3D pointing device and the moving speed of the content correspond to each other.

24. The method of claim 15, wherein, in the moving of the content, the movement of the content is controlled such that the motion direction of the 3D pointing device and the moving direction of the content correspond to each other.

25. The method of claim 15, further comprising displaying an indicator for indicating the motion of the 3D pointing device on the display unit displaying the content among the first and second display units.

26. The method of claim 15, wherein the motion of the 3D pointing device is at least one of a linear motion and a rotary motion.
